(19) United States
(12) Patent Application Publication
(10) Pub. No.: US 2026/0115078 A1
(43) Pub. Date: Apr. 30, 2026

(54) MASSAGER AND MASSAGER CONTROL METHOD

(71) Applicant: FUJI Medical Instruments MFG. CO.,LTD., Osaka (JP)

(72) Inventors: Meiman LIN, Xiamen (CN); Zhiming CHEN, Xiamen (CN)

(21) Appl. No.: 19/368,068

(22) Filed: Oct. 24, 2025

(30) Foreign Application Priority Data
Oct. 28, 2024 (CN) 202411515904.8

(51) Int. Cl. A61G 15/00; A61G 15/02; A61G 15/12; A61H 1/02

(52) U.S. Cl. CPC A61G 15/007; A61G 15/02; A61G 15/12; A61H 1/0218; A61H 2001/0233; A61H 2201/0149

(57) ABSTRACT

A massager is provided that includes a base portion having a first guide rail and a second guide rail, a support member having a front support member and a rear support member that are movable independently of each other, a seat portion supported on the base portion via the support member, and a seat portion driving device. The front support member is rotationally connected to a front end of the seat portion, and is driven by the seat portion driving device and guided by the first guide rail to move the front end of the seat portion in an up-and-down direction. The rear support member is rotationally connected to a rear end of the seat portion, and is driven by the seat portion driving device and guided by the second guide rail to move the rear end of the seat portion in the up-and-down direction.

### CROSS-REFERENCE TO RELATED APPLICATIONS

This application claims priority to Chinese Patent Application No. 202411515904.8 filed in China on October 28, 2024. The entire disclosure of Chinese Patent Application No. 202411515904.8 is hereby incorporated herein by reference.

### BACKGROUND

### Field of the Invention

The present invention relates to a massager and a massager control method.

### Background Information

A patent document CN205548034U discloses a chair including a base frame, a main support body, and a drive mechanism, wherein the main support body is movably supported on the base frame, and the drive mechanism drives, via a lateral swing arm, the main support body to switch between a normal position and a supine position.

### SUMMARY

However, in the above-mentioned chair, the adjustment range of the seat surface angle of a seat portion of the main support body is small. Consequently, the above-mentioned chair when used as a massage chair is prone to restrictions in the types of massage modes, and thus cannot provide massage modes that fit various postures of a treated subject. Still, if the lateral swing arm is lengthened in order to expand the adjustment range of the seat surface angle of the seat portion, it is likely to increase the overall size of the massage chair.

One object of the present disclosure is to provide a massager and a massager controlling method, in order to facilitate expanding the adjustment range of a seat surface angle of a seat portion, thereby providing an abundance of massage modes that can fit various postures of a treated subject.

In order to achieve the object described above, a massager according to the present disclosure includes a base portion having a first guide rail and a second guide rail, a support member having a front support member and a rear support member that are movable independently of each other, a seat portion supported on the base portion via the support member, and a seat portion driving device configured to adjust the seat portion by driving the support member. The front support member is rotationally connected to a front end of the seat portion. The front support member is configured to be driven by the seat portion driving device and guided by the first guide rail to move the front end of the seat portion in an up-and-down direction. The rear support member is rotationally connected to a rear end of the seat portion. The rear support member is configured to be driven by the seat portion driving device and guided by the second guide rail to move the rear end of the seat portion in the up-and-down direction.

Here, the statement “the support member includes a front support member and a rear support member that are movable independently of each other” means that one of the front and rear support members moves while the other one can remain stationary.

According to the massager of the present disclosure, the seat portion driving device is configured to independently actuate the front and rear support members, thereby enabling the seat portion to move relative to the base portion, such that the front end and the rear end of the seat portion are independently movable in the up-and-down direction, allowing for flexible adjustment of a seat surface angle of the seat portion and enhancing the variety of massage modes.

Furthermore, in the massager according to the present disclosure, the front support member includes a front connecting rod that is rotationally connected to the front end of the seat portion, and a first guided member that is arranged on the front connecting rod so as to move along the first guide rail, and the rear support member includes a rear connecting rod that is rotationally connected to the rear end of the seat portion, and a second guided member that is arranged on the rear connecting rod so as to move along the second guide rail.

Furthermore, in the massager according to the present disclosure, the front connecting rod includes a first front connecting rod and a second front connecting rod that are rotatably connected via a front rotating shaft portion, with an end of the first front connecting rod away from the front rotating shaft portion being rotationally connected to the front end of the seat portion, and an end of the second front connecting rod away from the front rotating shaft portion being rotationally connected to the base portion, and the rear connecting rod includes a first rear connecting rod and a second rear connecting rod that are rotatably connected via a rear rotating shaft portion, with an end of the first rear connecting rod away from the rear rotating shaft portion being rotationally connected to the rear end of the seat portion, and an end of the second rear connecting rod away from the rear rotating shaft portion being rotationally connected to the base portion.

According to the massager of the present disclosure, the posture and movement range of the seat portion can be effectively restricted by means of the cooperation between the front connecting rod and the first guide rail and the cooperation between the rear connecting rod and the second guide rail. By supporting the front and rear connecting rods via the first and second guide rails, the first and second guide rails can bear part of the gravity of the massager from the front and rear sides, respectively, allowing for a more stable lifting and lowering process for the seat portion. Furthermore, the front and rear support members are simple in structure and easy to manufacture.

Furthermore, in the massager according to the present disclosure, the first guided member is arranged at a midpoint of the first front connecting rod in a length direction, and the second guided member is arranged at a midpoint of the first rear connecting rod in a length direction.

Furthermore, in the massager according to the present disclosure, the first guided member includes a roller, and the second guided member includes a roller.

According to the massager of the present disclosure, when the seat portion driving device is in operation, it is easy to ensure smooth rotation of the first and second front connecting rods of the front connecting rod, and of the first and second rear connecting rods of the rear connecting rod.

Furthermore, in the massager according to the present disclosure, the seat portion driving device includes a front driving device with a telescopic actuating rod for the front connecting rod, and a rear driving device with a telescopic actuating rod for the rear connecting rod. The actuating rod for the front connecting rod has one end rotationally connected directly or indirectly to a midpoint of the first front connecting rod in a length direction, and the other end connected to the base portion. The actuating rod for the rear connecting rod has one end rotationally connected directly or indirectly to a midpoint of the first rear connecting rods in a length direction, and the other end connected to the base portion.

According to the massager of the present disclosure, the seat portion driving device features a compact design, provides sufficient driving force, and enables precise posture control of the front and rear connecting rods based on an amount of extension/retraction.

Furthermore, in the massager according to the present disclosure, in a front-to-back direction, the actuating rod for the front connecting rod and the actuating rod for the rear connecting rod are located between an end of the second front connecting rod and an end of the second rear connecting rod.

According to the massager of the present disclosure, the seat portion driving device is compact in the front-to-back direction, contributing to the miniaturization of the massager.

Furthermore, in the massager according to the present disclosure, the other end of the actuating rod for the front connecting rod is rotationally connected to a portion of the base portion close to the end of the second rear connecting rod, and the other end of the actuating rod for the rear connecting rod is rotationally connected to a portion of the base portion close to the end of the second front connecting rod.

Within a limited space in the front-to-back direction, the extension/retraction range of each actuating rod is limited. The location and angle for arranging each actuating rod affect the seat portion’s movement distance converted from this amount of extension/retraction.

According to the massager of the present disclosure, it is easy to increase the amounts of movement, which are correspondingly generated based on the amounts of extension/retraction of the actuating rods for the front and rear connecting rods, of the front and rear ends of the seat portion in the up-and-down direction, thereby further expanding the adjustment range of the seat surface angle of the seat portion.

Furthermore, in the massager according to the present disclosure, the first guide rail is formed such that a height thereof increases as extending toward a front portion of the massager, and the second guide rail is formed such that a height thereof increases as extending toward a rear portion of the massager.

According to the massager of the present disclosure, the dimension of the seat portion in the front-to-back direction can be effectively utilized to expand the movement range of the support member in the up-and-down direction, thereby further expanding the adjustment range of the seat surface angle of the seat portion.

Furthermore, in the massager according to the present disclosure, the massager further includes a leg support portion rotationally connected to the front end of the seat portion, and a backrest portion rotationally connected to the base portion or to the rear end of the seat portion.

According to the massager of the present disclosure, the massage modes can be further enriched by enabling the leg support portion and the backrest portion to rotate relative to the seat portion.

Furthermore, in the massager according to the present disclosure, the massager further includes a leg support portion driving device causing the leg support portion to move relative to the seat portion, and a backrest portion driving device causing the backrest portion to move relative to the base portion or the seat portion.

Furthermore, in order to achieve the object described above, a massager control method according to the present disclosure is provided for controlling the massager described above. The massager control method includes controlling the seat portion driving device, the leg support portion driving device, and the backrest portion driving device to cause the massager to perform at least one of a stand-up assist mode, a lying-flat mode, a zero-gravity mode, a compression mode, and a lumbar stretch mode. In the stand-up assist mode, a front end of a seat surface of the seat portion is positioned lower than or substantially flush with a rear end. In the lying-flat mode, a seat surface angle of the seat portion is adjusted such that the seat portion, the leg support portion, and the backrest portion work together to achieve a state allowing for lying-flat of a treated subject. In the zero-gravity mode, the front end of the seat surface of the seat portion is positioned higher than the rear end, an end of the leg support portion away from the seat portion is positioned lower than an end of the leg support portion close to the seat portion, and an end of the backrest portion away from the seat portion is positioned higher than an end of the backrest portion close to the seat portion. In the compression mode, the end of the leg support portion away from the seat portion and the end of the backrest portion away from the seat portion are brought closer to each other. In the lumbar stretch mode, the front end of the seat surface of the seat portion is positioned lower than the rear end, and at least part of the backrest portion close to the seat portion is positioned lower than the rear end of the seat portion.

According to the massager of the present disclosure, the front driving device and the rear driving device are configured to actuate the front support member and the rear support member to move, respectively, thereby enabling the front end and the rear end of the seat portion to move independently in the up-and-down direction. In this way, the seat surface angle of the seat portion can be freely adjusted to provide an abundance of massage modes that can fit various postures of a treated subject. According to the massager control method of the present disclosure, the front and rear ends of the seat portion are moveable independently in the up-and-down direction by means of the support member and the driving for the support member, and this is combined with the matched angles of the leg support portion and the backrest portion to achieve switching between a variety of massage modes, such that the massage modes are enriched within a limited space and a simplified structure.

### BRIEF DESCRIPTION OF THE DRAWINGS

FIG. 1 is a side view schematically showing a rack of a massager according to one embodiment of the present disclosure, showing a state in a stand-up assist mode;

FIG. 2 is a side view schematically showing the rack of the massager according to the embodiment of the present disclosure, showing a state in a lying-flat mode;

FIG. 3 is a side view schematically showing the rack of the massager according to the embodiment of the present disclosure, showing a state in a zero-gravity mode;

FIG. 4 is a side view schematically showing the rack of the massager according to the embodiment of the present disclosure, showing a state in a lumbar stretch mode;

FIG. 5 is a side view schematically showing the rack of the massager according to the embodiment of the present disclosure, showing a state in a compression mode;

FIG. 6 is an exploded perspective view schematically showing the rack of the massager according to the embodiment of the present disclosure;

FIG. 7 is a perspective view schematically showing a partial structure of the rack of the massager according to the embodiment of the present disclosure;

FIG. 8 is another perspective view schematically showing a partial structure of the rack of the massager according to the embodiment of the present disclosure;

FIG. 9 is another perspective view schematically showing a partial structure of the rack of the massager according to the embodiment of the present disclosure;

FIG. 10 is another perspective view schematically showing a partial structure of the rack of the massager according to the embodiment of the present disclosure;

FIG. 11 is a schematic diagram schematically showing a movement mechanism of the rack of the massager according to the embodiment of the present disclosure;

FIG. 12 is a schematic diagram schematically showing the movement mechanism of a rack of a massager according to a modified embodiment of the present disclosure; and

FIG. 13 is a perspective view schematically showing a partial structure of the rack of the massager according to another modified embodiment of the present disclosure.

### DETAILED DESCRIPTION OF EMBODIMENTS

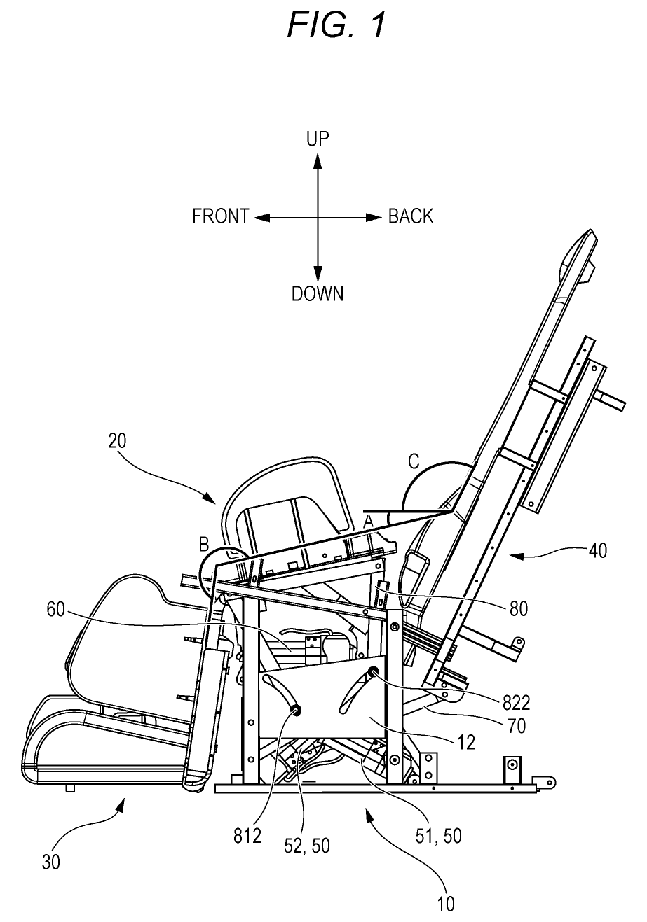

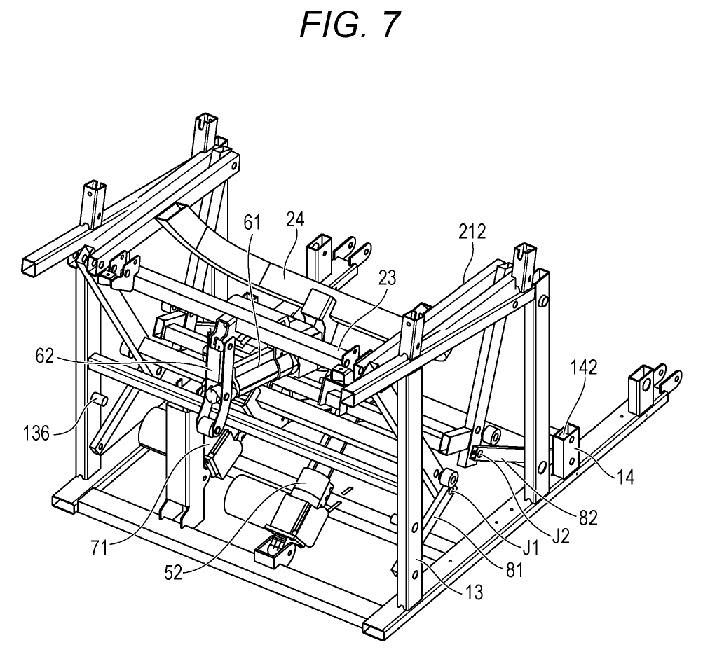

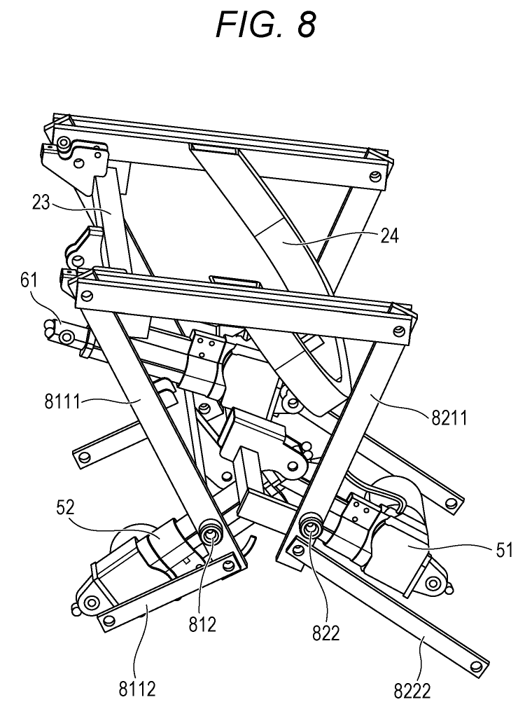

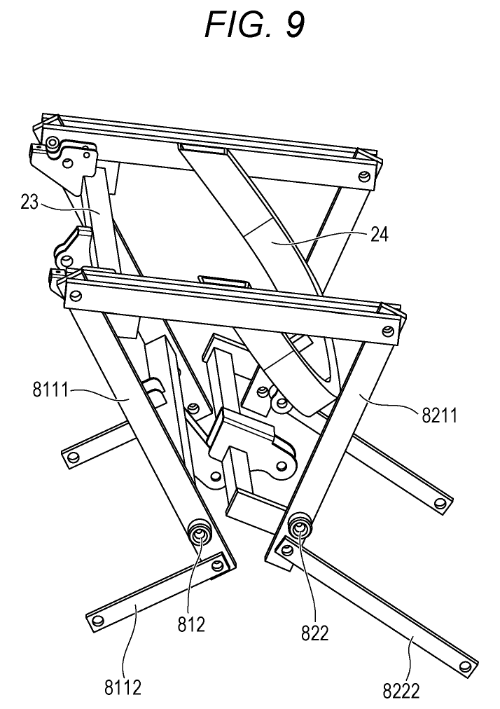

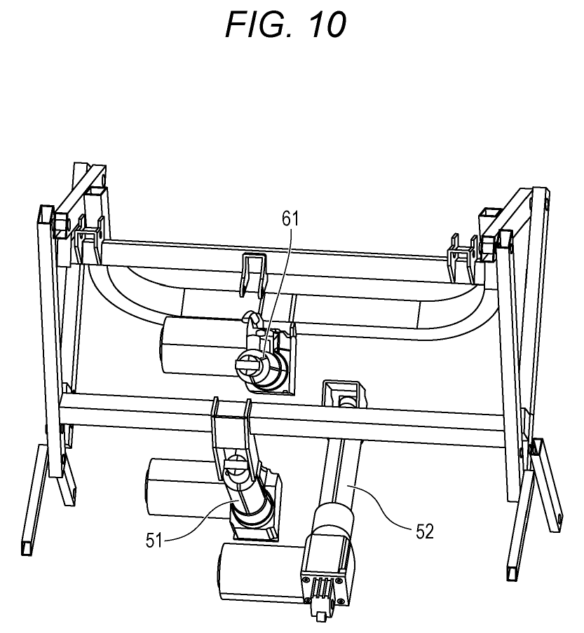

Selected embodiments will now be explained with reference to the drawings. A massager 1 according to one embodiment of the present disclosure is illustrated in the form of a massage chair with reference to FIGS. 1 to 10. However, the massager of the present disclosure is not limited to the use in massage chairs and can also be used in other massagers such as massage beds.

For convenience of illustration, the orientation of a treated subject seated in the massager during observation is used to describe the structural orientation of the massager 1. For example, the front side (forward side) of the treated subject seated on the massager 1 during observation is referred to as “front side” or “forward”, the rear side (back side) of the treated subject is referred to as “rear side” or “back”, the upper side (head side) of the treated subject is referred to as “upper side” or “top”, the lower side (foot side) of the treated subject is referred to as “lower side” or “bottom”, the right side of the treated subject is referred to as “right side” or “right”, and the left side of the treated subject is referred to as “left side” or “left”.

### Overall Structure of Massager

As shown in FIG. 1, the massager 1 includes a base portion or base 10, a seat portion or seat 20, and a seat portion driving device or driver 50. The seat portion 20 is supported on the base portion 10 via a support member or support 80. The seat portion driving device 50 drives the support member 80 to move, to thus cause the seat portion 20 to move relative to the base portion 10 and adjust a seat surface angle A of the seat portion 20. The seat surface angle A is an angle formed by an upper surface portion (seat surface) of the seat portion 20 in contact with the buttocks and thighs of a treated subject during use, relative to the horizontal plane. It is also called a seat portion angle.

Here, as shown in FIG. 1, the massager 1 further includes a leg support portion or leg support 30 and a backrest portion or backrest 40. The leg support portion 30 is rotationally connected to a front end of the seat portion 20. The backrest portion 40 is rotationally connected to the base portion 10.

Furthermore, as shown in FIG. 1, the massager 1 further includes a leg support portion driving device or driver 60 and a backrest portion driving device or driver 70. The leg support portion driving device 60 causes the leg support portion 30 to rotate relative to the seat portion 20. The backrest portion driving device 70 causes the backrest portion 40 to rotate relative to the base portion 10.

Furthermore, although not shown, the massager 1 further includes a control portion or electronic controller for controlling the seat portion driving device 50, the leg support portion driving device 60, and the backrest portion driving device 70. Specifically, as well known in the field of massagers, the control portion includes at least one processor having a CPU (Central Processing Unit) and a storage device or computer memory, and an interface for communicating with each device is included as necessary.

### Structure of Base Portion

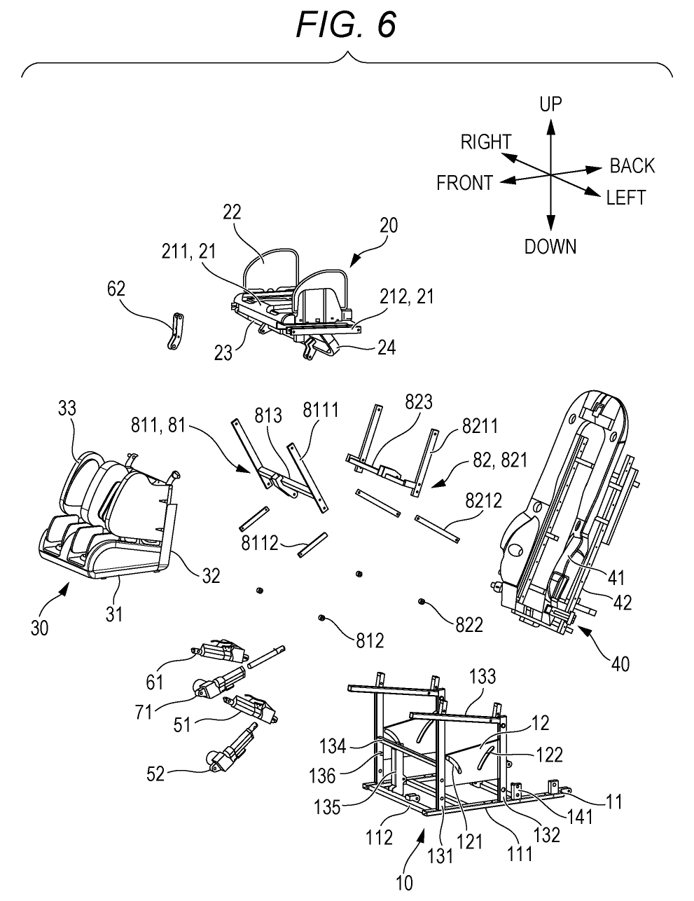

As shown in FIGS. 1 and 6, the base portion 10 is a support frame for overall support of functional components including the leg support portion 30, the seat portion 20, and the backrest portion 40.

Although not shown here, a base covering portion (e.g., made of plastic or the like) is typically provided in practice to cover the base portion 10.

Furthermore, as shown in FIGS. 1, 6, and FIG. 7, the base portion 10 includes a bottom portion or structural frame 11, guide rail portions or plates 12, a first connecting portion or structural frame 13, and a second connecting portion or structural frame 14. A bottom surface of the bottom portion 11 is in contact with a support surface such as the ground, for example, and the surface where the bottom portion 11 is located may also be regarded as the bottom surface. The guide rail portions 12 are located above the bottom portion 11 and are connected to the bottom portion 11 via the first connecting portion 13. The second connecting portion 14 protrudes upward from the bottom portion 11, and is connected to a lower portion of the support member 80.

Specifically, as shown in FIGS. 1, 6, and FIG. 7, the bottom portion 11 is formed as a bearing base for the support frame, and includes: a pair of first bottom cross rods 111 extending in a front-to-back direction and spaced apart in a left-to-right direction; and a plurality of second bottom cross rods 112 extending in the left-to-right direction, arranged at intervals in the front-to-back direction, and connecting the pair of the first bottom cross rods 111 to each other.

The guide rail portions 12 are shaped as plates each with a thickness direction consistent with the left-to-right direction. A pair of the guide rail portions 12 is arranged at intervals in the left-to-right direction. The pair of the guide rail portions 12 each has a first guide rail 121 and a second guide rail 122. Each first guide rail 121 is composed of a groove. Each first guide rail 121 has its upper end positioned more forward than its lower end, and is formed in a curved shape such that its height increases progressively as it extends toward the front portion of the massager 1. In the illustrated example, each first guide rail 121 is formed as a segment of a curve that is convex toward the rear and upper side, and gradually rises from the rear and lower side to the front and upper side. However, the shape is not limited to this configuration, and may alternatively be formed as a curve that is convex toward the front and lower side, or as a curve that is convex toward either the front side or the rear side only. Each second guide rail 122 is positioned rearward of each first guide rail 121, and is formed as a groove. Each second guide rail 122 has its upper end positioned more rearward than its lower end, and is formed in a curved shape such that its height increases progressively as it extends toward the rear portion of the massager 1. In the illustrated example, each second guide rail 122 is formed as a segment of a curve that is convex toward the front and upper side, and gradually rises from the front and lower side to the rear and upper side. However, the shape is not limited to this configuration, and may alternatively be formed as a curve that is convex toward the rear and lower side, or as a curve that is convex toward either the front side or the rear side only. Each first guide rail 121 and each second guide rail 122 are approximately the same in length and position in the up-and-down direction. In this embodiment, the curvature of each first guide rail 121 and each second guide rail 122 varies along the extending direction of the respective curve. However, the shape is not limited to this configuration, and each first guide rail 121 and each second guide rail 122 may alternatively be formed as a segment of curve (e.g., a circular arc) with a constant curvature, and may have the same curvature.

The first connecting portion 13 includes a pair of first vertical rods 131, a pair of second vertical rods 132, a pair of first cross rods 133, a second cross rod 134, and a third vertical rod 135. The pair of the first vertical rods 131 extends in the up-and-down direction and is spaced apart in the left-to-right direction, the lower ends of the pair of the first vertical rods 131 are connected near the front ends of the first bottom cross rods 111, and the midpoints of the pair of the first vertical rods 131 in the up-and-down direction are fixedly connected to the front ends of the guide rail portions 12 in the up-and-down direction. The pair of the first vertical rods 131 is further provided with first stop pins 136, which may be butted with second front connecting rods 8112 of the support member 80 to be described below to limit the rotation ranges of the second front connecting rods 8112, thereby preventing the second front connecting rods 8112 from rotating to the front sides of the first stop pins 136. The pair of the second vertical rods 132 is located on the rear sides of the pair of the first vertical rods 131, respectively, and is spaced apart from the first vertical rods 131. The pair of the second vertical rods 132 extends in the up-and-down direction and is spaced apart in the left-to-right direction, the lower ends of the pair of the second vertical rods 132 are fixedly connected approximately to the centers of the first bottom cross rods 111 in the length direction, and the midpoints of the second vertical rods 132 in the up-and-down direction are connected to the rear ends of the guide rail portions 12. Hence, each guide rail portion 12 extends in the front-to-back direction between the first and second vertical rods 131 and 132 arranged at intervals. The pair of the first cross rods 133 extends inclinedly relative to the front-to-back direction (in the example as shown, the front end of each first cross rod 133 is higher than the rear end, but it is not limited thereto), is spaced apart in the left-to-right direction, and connects the upper ends of the first vertical rods 131 on both sides to the upper ends of the second vertical rods 132, respectively. The second cross rod 134 extends in the left-to-right direction, and connects the midpoints of the pair of the first vertical rods 131 in the up-and-down direction. The third vertical rod 135 connects the second cross rod 134 to the midpoint of the foremost second bottom cross rod 112 in the length direction.

The second connecting portion 14 includes a pair of vertical rods 141. The pair of the vertical rods 141 extends in the up-and-down direction, is spaced apart in the left-to-right direction, and is rotationally connected to second rear connecting rods 8212 of the support member 80 to be described below, respectively. The pair of the vertical rods 141 is slightly further back than the second vertical rods 132, and the lower ends of the pair of the vertical rods 141 are fixedly connected approximately to the centers of the first cross rods 111 in the length direction. The pair of the vertical rods 141 is further provided with second stop pins 142, which may be butted with the second rear connecting rods 8212 of the support member 80 to be described below, to limit the rotation ranges of the second rear connecting rods 8212. For example, the second stop pins 142 may prevent the second rear connecting rods 8212 from rotating to positions further backward than the second stop pins 142. The second stop pins 142 may also be arranged on the second vertical rods 132, or stop members may be arranged on the guide rail portions 12 to limit the rotation range of the support member 80. The support member 80 may also be rotationally connected to the second vertical rods 132.

### Structure of Seat Portion

As shown in FIGS. 1 and 6, the seat portion 20 is a support frame for supporting the buttocks and thighs of a treated subject.

Although not shown here, a seat portion covering portion (a portion that is in contact with the buttocks and thighs of the treated subject during use and that is made of leather, fabric or other materials, for example) is typically provided in practice to cover the seat portion 20.

Furthermore, as shown in FIGS. 1, 6, and FIG. 7, the seat portion 20 includes a seat body or main body 21, a pair of lateral massage members 22, a first connecting rod 23, and a second connecting rod 24. The top surface of the seat body 21 supports, for example, the buttocks or thighs of the treated subject. The pair of the lateral massage members 22 protrude upward from the seat body 21 to massage, for example, the buttocks or thighs of the treated subject. For example, each lateral massage members 22 includes a massage mechanism configured to apply pressing, kneading or vibration to the treated subject, and may include at least one of a motor-driven roller, an inflatable airbag or a vibrator, but is not limited thereto. The first connecting rod 23 functions to connect a leg portion driving connecting rod 62 of the leg support portion driving device 60 to be described below. The second connecting rod 24 functions to connect a leg portion actuating rod 61 of the leg support portion driving device 60 to be described below.

Specifically, the seat body 21 includes a seat plate portion or plate 211 and a pair of seat portion cross rods 212. The seat plate portion 211 is shaped as a rectangle with a width direction approximately consistent with the left-to-right direction. The pair of the seat portion cross rods 212 is respectively fixed to the edges on both left and right sides of the seat plate portion 211. The pair of lateral massage members 22 extends upward from the edges on both left and right sides of the seat plate portion 211. Both ends of the first connecting rod 23 are connected to the lower portions on the front end sides of the pair of the seat portion cross rods 212, respectively. The second connecting rod 24 is approximately U-shaped, with both ends protruding respectively from the seat body 21 toward the lower side while extending inclinedly toward the rear side, and then connecting each other in the left-to-right direction. The two ends are connected to the midpoints of the pair of the seat portion cross rods 212 in the length direction, respectively.

### Structure of Support Member

As shown in FIGS. 1, 6, 8, 9, and FIG. 10, the support member 80 includes a front support member or frame 81 and a rear support member or frame 82 that are movable independently of each other. The front support member 81 is rotationally connected to the front end of the seat portion 20, and is driven by the seat portion driving device 50 (specifically, a front driving device to be described below) and guided by the first guide rails 121 to move to thus drive the front end of the seat portion 20 to move in the up-and-down direction. The rear support member 82 is rotationally connected to the rear end of the seat portion 20, and is driven by the seat portion driving device 50 (specifically, a rear driving device to be described below) and guided by the second guide rails 122 to move to thus drive the rear end of the seat portion 20 to move in the up-and-down direction.

Here, as shown in FIGS. 1, 6, 7, 8, 9, and FIG. 10, the front support member 81 includes: front connecting rods 811 rotationally connected to the front end of the seat portion 20; and first guided members 812 that are arranged on the front connecting rods 811 and move along the first guide rails 121. The rear support member 82 includes: rear connecting rods 821 rotationally connected to the rear end of the seat portion 20, and second guided members 822 that are arranged on the rear connecting rods 821 and move along the second guide rails 122.

Specifically, a pair of the front connecting rods 811 is arranged at intervals in the left-to-right direction. The pair of the front connecting rods 811 each includes a first front connecting rod 8111 and a second front connecting rod 8112 that are rotatably connected via a front rotating shaft portion J1. The end (the upper end in the illustrated example) of the first front connecting rod 8111 away from the front rotating shaft portion J1 is rotationally connected to the front end (the front end of the seat portion cross rod 212 of the seat body 21 in the illustrated example) of the seat portion 20, and the end (the lower end in the illustrated example) of the second front connecting rod 8112 away from the front rotating shaft portion J1 is rotationally connected to the base portion 10 (the first vertical rod 131 in the illustrated example). The length of each first front connecting rod 8111 is greater than the length of each second front connecting rod 8112. A pair of the rear connecting rods 821 is arranged at intervals in the left-to-right direction. The pair of the rear connecting rods 821 each includes a first rear connecting rod 8211 and a second rear connecting rod 8212 that are rotatably connected via a rear rotating shaft portion J2. The end (the upper end in the illustrated example) of the first rear connecting rod 8211 away from the rear rotating shaft portion J2 is rotationally connected to the rear end of the seat portion 20 (the rear end of the seat portion cross rod 212 of the seat body 21 in the illustrated example), and the end (the lower end in the illustrated example) of the second rear connecting rod 8212 away from the rear rotating shaft portion J2 is rotationally connected to the base portion 10 (the first vertical rod 141 in the illustrated example). The length of each first rear connecting rod 8211 is greater than the length of each second rear connecting rod 8212. A pair of the first guided members 812 is arranged at intervals in the left-to-right direction. The pair of the first guided members 812 (which are rollers in the illustrated example, and may also be sliders or the like) is arranged at the midpoints of the pair of the first front connecting rods 8111 in a length direction. A pair of the second guided members 822 is arranged at intervals in the left-to-right direction. The pair of the second guided members 822 (which are rollers in the illustrated example, and may also be sliders or the like) is arranged at the midpoints of the first rear connecting rods 8211 in a length direction.

Furthermore, as shown in FIGS. 1, 6, 8, 9, and FIG. 10, the front support member 81 further includes a front cross rod 813 for connecting the front connecting rods 811 on both the left and right sides. In this embodiment, the front cross rod 813 connects the midpoints of the left and right first front connecting rods 8111 in the length direction. The front cross rod 813 is connected to the first front connecting rods 8111 at a distance from the front rotating shaft portion J1. The pair of the first guided members 812 is respectively located outside the connecting positions between the front cross rod 813 and the left and right first front connecting rods 8111. The rear support member 82 further includes a rear cross rod 823 for connecting the rear connecting rods 821 on both the left and right sides. In this embodiment, the rear cross rod 823 connects the midpoints of the left and right first rear connecting rods 8211 in the length direction. The rear cross rod 823 is connected to the first rear connecting rods 8211 at a distance from the rear rotating shaft portion J2. The pair of the second guided members 822 is respectively located outside the connecting positions between the rear cross rod 823 and the left and right first rear connecting rods 8211. As described above, in this embodiment, the first guided members 812 and the second guided members 822 are spaced apart from the front rotating shaft portion J1 and the rear rotating shaft portion J2, respectively. However, it is not limited to this, the first guided members 812 and the second guided members 822 are also correspondingly arranged outside the front rotating shaft portion J1 and the rear rotating shaft portion J2, respectively. The front cross rod 813 and the rear cross rod 823 may also be connected to the second front connecting rods 8112 and the second rear connecting rods 8212, respectively, or may be connected to the front rotating shaft portion J1 and the rear rotating shaft portion J2 on the left and right sides, respectively.

### Structure of Seat Portion Driving Device

As shown in FIGS. 1 and 6, the seat portion driving device 50 includes a front driving device and a rear driving device.

Furthermore, as shown in FIGS. 1, 6, 7, and FIG. 8, the front driving device is a telescopic actuating rod 51 for the front connecting rods 811. The actuating rod 51 for the front connecting rods 811 has one end rotationally connected directly or indirectly to the midpoints of the front connecting rods 811 in the length direction, and has the other end connected to the base portion 10 (the rearmost second bottom cross rod 112 in the illustrated example). The rear driving device is a telescopic actuating rod 52 for the rear connecting rods 821. The actuating rod 52 for the rear connecting rods 821 has one end rotationally connected directly or indirectly to the midpoints of the rear connecting rods 821 in the length direction, and has the other end connected to the base portion 10 (the foremost second bottom cross rod 112 in the illustrated example). In the illustrated embodiment, the actuating rods 51 and 52 are each operatively coupled to an electronic actuator or motor that is operatively connected to the control portion for extending or retracting the actuating rods 51 and 52, for example.

Specifically, the actuating rod 51 for the front connecting rods 811 has a first portion and a second portion capable of extending and retracting with respect to the first portion. The lower end (located at the first portion) of the actuating rod 51 for the front connecting rods 811 is hinged and fixed with the base portion 10, in particular, the rearmost second bottom cross rods 112, and can circumferentially rotate around the second bottom cross rods 112. The upper end (located at the second portion) of the actuating rod 51 for the front connecting rods 811 is hinged with the front cross rod 813, and in this embodiment, is hinged and fixed with the front cross rod 813 that connects the midpoints of the pair of the first front connecting rods 8111 in the length direction.

Similarly, the actuating rod 52 for the rear connecting rods 821 has a first portion and a second portion capable of extending and retracting with respect to the first portion. The lower end (located at the first portion) of the actuating rod 52 for the rear connecting rods 821 is hinged and fixed with the base portion 10, in particular, the foremost second bottom cross rods 112, and can circumferentially rotate around the second bottom cross rods 112. The upper end (located at the second portion) of the actuating rod 52 for the rear connecting rods 821 is hinged with the rear cross rod 823, and in this embodiment, is hinged and fixed with the rear cross rod 823 that connects the midpoints of the pair of the first rear connecting rods 8211 in the length direction.

As shown in FIGS. 1, 7, and FIG. 8, in the front-to-back direction, the actuating rod 51 for the front connecting rods 811 and the actuating rod 52 for the rear connecting rods 821 are located between the end (the lower end in the illustrated example) of the second front connecting rod 8112 away from the front rotating shaft portion J1 and the end (the lower end in the illustrated example) of the second rear connecting rod 8212 away from the rear rotating shaft portion J2.

Through the extension and retraction of the seat portion driving device 50, the seat portion 20 may be driven to rotate relative to its hinged portion with the support member 80, to drive the front or rear end of the seat portion 20 to move in the up-and-down direction, thereby changing the positional relationship between the seat surface of the seat portion 20 and the base portion 10, and changing the seat surface angle A formed by the seat surface of the seat portion 20 relative to the horizontal plane. As described later, various massager states can be created by adjusting the seat surface angle A of the seat portion 20 and controlling the leg support portion 30 and the backrest portion 40.

### Leg Support Portion

As shown in FIGS. 1 and 6, the leg support portion 30 is a support frame for supporting the lower limbs of the treated subject.

Although not shown here, a leg portion covering portion (a portion that is in contact with the shanks of the treated subject during use and that is made of leather, fabric or other materials, for example) is typically provided in practice to cover the leg support portion 30.

Furthermore, as shown in FIGS. 1 and 6, the leg support portion 30 includes a foot board 31, a connecting plate 32, and partition plates 33. The foot board 31 is provided for holding the feet of the treated subject, and is approximately shaped as a rectangular plate. The foot board 31 has a length direction consistent with the left-to-right direction. The connecting plate 32 rotationally connects the end (the upper end in the illustrated example) of the foot board 31 to the front end (the front ends of the pair of the cross rods 212 of the seat portion 20 in the illustrated example) of the seat portion 20. The partition plates 33 protrude from the foot board 31 and the connecting plate 32 (to extend forward and upward in the illustrated example), and three partition plates 33 are arranged at intervals in the left-to-right direction. Spaces for accommodating the legs of the treated subject are formed between adjacent partition plates 33.

### Structure of Leg Support Portion Driving Device

As shown in FIGS. 1 and 6, the leg support portion driving device 60 is located between the seat surface of the seat portion 20 and the bottom portion 11 of the base portion 10 in the up-and-down direction.

Here, as shown in FIGS. 1 and 6, the leg support portion driving device 60 includes a leg portion actuating rod 61, and a leg portion driving connecting rod 62. In the illustrated embodiment, the leg portion actuating rod 61 is operatively coupled to an electronic actuator or motor that is operatively connected to the control portion for extending or retracting the leg portion actuating rod 61, for example.

Specifically, the leg portion actuating rod 61 has a first portion and a second portion capable of extending and retracting with respect to the first portion. The rear end (located at the first portion) of the leg portion actuating rod 61 is hinged and fixed with the seat portion 20, in particular, the second connecting rod 24, and can circumferentially rotate around the second connecting rod 24. The front end (located at the second portion) of the leg portion actuating rod 61 can extend and retract relative to its rear end, is connected to the midpoint of the leg portion driving connecting rod 62 in the length direction, and can rotate in the front-to-back direction relative to its connection with the leg portion driving connecting rod 62. The leg portion driving connecting rod 62 has one end hinged and fixed with the first connecting rod 23, and can circumferentially rotate around the first connecting rod 23. A roller is arranged on the other end of the leg portion driving connecting rod 62. The roller of the leg portion driving connecting rod 62 is in sliding contact with the leg support portion 30 in a manner that the roller can support the leg support portion 30.

In addition, when the leg support portion driving device 60 drives the second portion of the leg portion actuating rod 61 to extend and retract with respect to its first portion, the extension and retraction of the second portion drive the leg portion driving connecting rod 62 to move synchronously, by means of its hinge joint with the midpoint of the leg portion driving connecting rod 62. Moreover, one end of the leg portion driving connecting rod 62 may be rotationally hinged to the first connecting rod 23 of the seat portion 20, such that the roller arranged at the front end of the leg portion driving connecting rod 62 may change in position in the front-to-back and up-and-down directions, while the leg portion driving connecting rod 62 rotates relative to the front side of the seat portion 20. The change of the roller in the position in the front-to-back and up-and-down directions causes the leg support portion 30 supported by the roller to move following the roller. Hence, the leg support portion 30 rotates relative to the seat portion 20 to change a leg portion angle B formed by the front surface of the leg support portion 30 in FIG. 1 and the seat surface of the seat portion 20.

### Backrest Portion

As shown in FIGS. 1 and 6, the backrest portion 40 is a support frame for supporting the back of the treated subject, and is rotatably connected to the rear upper end of the base portion 10 (the upper end of the second vertical rod 132 or the rear end of the first cross rod 133 of the first connecting portion 13).

Although not shown here, a backrest portion covering portion (a portion that is in contact with the back of the treated subject during use and that is made of leather, fabric or other materials, for example) is typically provided in practice to cover the backrest portion 40.

Here, as shown in FIGS. 1 and 6, the backrest portion 40 includes a plate portion or plate 41 and a frame portion or frame 42. The plate portion 41 is approximately U-shaped, and the upper ends of the pair of the second vertical rods 132 are rotationally connected near both ends of a U-shaped opening. The frame portion 42 and the plate portion 41 are laminated in the thickness direction of the backrest portion 40 (in the illustrated example, the frame portion 42 is behind the plate portion 41). The lower end of the frame portion 42 (i.e., the end close to both ends of the U-shaped opening of the plate portion 41) is rotationally connected to the backrest portion driving device 70.

### Structure of Backrest Portion Driving Device

As shown in FIGS. 1 and 6, the backrest portion driving device 70 is located between the seat surface of the seat portion 20 and the bottom portion 11 of the base portion 10 in the up-and-down direction.

Here, as shown in FIGS. 1 and 6, the backrest portion driving device 70 includes a backrest portion actuating rod 71. In the illustrated embodiment, the backrest portion actuating rod 71 is operatively coupled to an electronic actuator or motor that is operatively connected to the control portion for extending or retracting the backrest portion actuating rod 71, for example.

Specifically, the backrest portion actuating rod 71 has a first portion and a second portion capable of extending and retracting with respect to the first portion. The first portion is rotatably connected to the base portion 10. The second portion is rotatably connected to the backrest portion 40. For example, the lower end (located at the first portion) of the backrest portion actuating rod 71 is hinged with the base portion 10, in particular, the third vertical rod 135. The upper end (located at the second portion) of the backrest portion actuating rod 71 is hinged with the backrest portion 40, in particular, the lower end of the frame portion 42.

Furthermore, the extension and retraction of the backrest portion driving device 70 can drive the backrest portion 40 to rotate with respect to its hinged portion with the base portion 10, thereby changing a backrest portion angle C formed by the front surface of the backrest portion 40 and the seat surface of the seat portion 20.

### Massage Modes

By controlling the seat portion driving device 50, the leg support portion driving device 60, and the backrest portion driving device 70, for example, by extending and retracting the seat portion driving device 50, the leg support portion driving device 60, and the backrest portion driving device 70, the massager 1 can provide any one of the massager states including a stand-up assist mode, a lying-flat mode, a zero-gravity mode, a lumbar stretch mode, and a compression mode, and can be switched between these states. Hence, the treated subject can be provided with the experience of receiving massages in different postures or body positions, and it is convenient for the treated subject to stand up after the massage is finished.

The stand-up assist mode refers to a state of facilitating the treated subject to stand up from the massager 1.

Here, as shown in FIG. 1, in the stand-up assist mode, the rollers constituting the first guided members 812 are located at the lowermost ends of the grooves constituting the first guide rails 121, and the rollers constituting the second guided members 822 are located at the uppermost ends of the grooves constituting the second guide rails 122. Hence, the front end of the seat surface (the upper surface of the seat plate portion 211 in the illustrated example, and in a case where the seat portion covering portion is provided, it corresponds to a portion of the seat portion covering portion that is in contact with the buttocks and thighs of the treated subject during use) of the seat portion 20 is lower than the rear end. The seat surface angle A formed by the seat surface of the seat portion 20 relative to the horizontal plane (the bottom surface of the base portion 10) may be formed at an angle of 5°-40°. Certainly, the seat surface angle A may be appropriately designed. For example, the seat surface angle A in the stand-up assist mode may be preset to a predetermined angle of 5°, 10°, 15°, 20°, 25°, 30°, etc., or the seat surface angle A may be fine-tuned and set to an angle satisfactory to the treated subject through the control of the treated subject. Also, the backrest portion 40 is in a state where it erects with respect to the seat portion 20, for example, the backrest portion angle C is close to 90°.

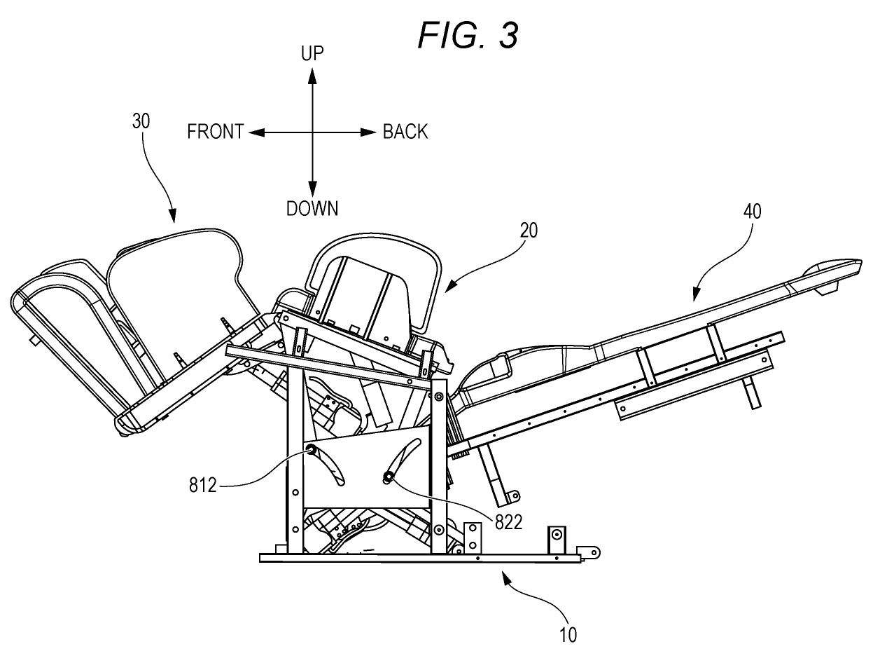

For example, when the massager 1 needs to be adjusted from the zero-gravity mode (FIG. 3) to be described below to the stand-up assist mode, the extension and retraction of the actuating rods 51 and 52 of the seat portion driving device 50 for the front and rear connecting rods 811 and 821 are controlled respectively to adjust the seat surface angle A of the seat portion 20, such that the rear end of the seat portion 20 is higher than the front end, thereby making it suitable for the treated subject to stand up from the massager 1. Specifically, if the actuating rod 52 for the rear connecting rods 821 is controlled to extend, the rear cross rod 823 hinged to the second portion of the actuating rod 52 for the rear connecting rods 821 is pushed to move backward, and the rear cross rod 823, together with the first rear connecting rods 8211 and the second rear connecting rods 8212, achieves a tendency of rotating backward via the rear rotating shaft portion J2. Hence, the second guided members 822 located on the left and right sides of the rear connecting rods 821 achieve a tendency of moving backward. Moreover, the second guided members 822 are movably engaged with the second guide rails 122 that gradually rise from the front and lower side to the rear and upper side, and when the second guided members 822 are driven backward by the rear connecting rods 821, the second guided members 822 also achieve a tendency of move upward, together with the corresponding position of the rear connecting rods 821. Hence, the tendency of the second guided members 822 moving both backward and upward causes the angles between the first rear connecting rods 8211 and the second rear connecting rods 8212 to increase from small to big, such that the upper ends of the first rear connecting rods 8211 undergo displacement in the up-and-down direction to move upward and drive the rear end of the seat portion 20to rise. When the rear end of the seat portion 20 rises, the seat surface of the seat portion 20 rotates by taking the hinged positions between the front end of the seat portion 20 and the first front connecting rods 8111 as the rotation axes, leading to a change in the seat surface angle A.

If the actuating rod 51 for the front connecting rods 811 is controlled to retract, the front cross rod 813 hinged to the second portion of the actuating rod 51 for the front connecting rods 811 is driven to move backward, and the front cross rod 813, together with the first front connecting rods 8111 and the second front connecting rods 8112, achieves the tendency of rotating backwards via the front rotating shaft portion J1. Hence, the first guided members 812 located on both the left and right sides of the front connecting rods 811 achieve the tendency of moving backward. Moreover, the first guided members 812 are movably engaged in the first guide rails 121 that gradually descend from the front and upper side to the rear and lower side; and when the first guided members 812 are driven backward by the front connecting rods 811, the first guided members 812, together with the corresponding positions of the front connecting rods 811, achieve the tendency of moving downward. Hence, the tendency of the first guided members 812 moving both backward and downward causes the angle between the first front connecting rods 8111 and the second front connecting rods 8112 to decrease from big to small, such that the upper ends of the first front connecting rods 8111 undergo displacement in the up-and-down direction to move downward and drive the front end of the seat portion 20 to descend. When the front end of the seat portion 20 is lowered, the seat surface of the seat portion 20 rotates by taking the hinge positions between the rear end of the seat portion 20 and the first rear connecting rods 8211 as the rotation axes, leading to a change in the seat surface angle A.

As described above, the driving principle of adjusting from the zero-gravity mode to be described later to the stand-up assist mode is illustrated, and the description of adjusting from the stand-up assist mode to the zero-gravity mode is omitted. The extension/retraction states of the actuating rods 51 and 52 for the front and rear connecting rods 811 and 821, respectively, may be performed in a time order, or controlled simultaneously, and it is not limited to this embodiment.

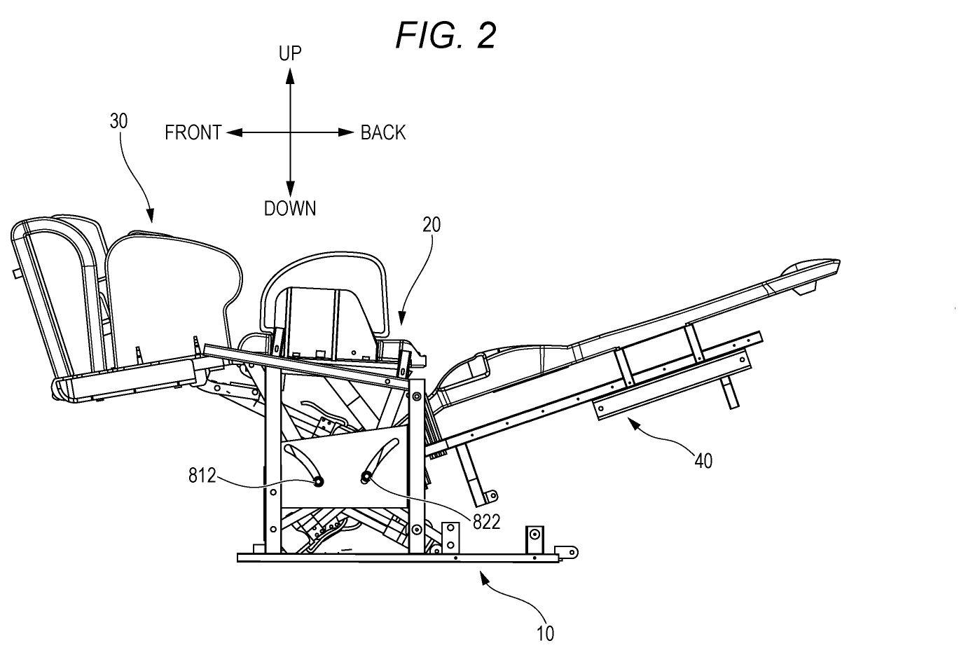

Furthermore, as shown in FIG. 2, in the lying-flat mode, the rollers constituting the first guided members 812 are located at the lowermost ends of the grooves constituting the first guide rails 121, while the rollers constituting the second guided members 822 are located at the lowest ends of the grooves constituting the second guide rails 122. Hence, the seat surface angle A of the seat portion 20 is adjusted (in the illustrated example, the front end of the seat surface is slightly higher than the rear end). Also, in the lying-flat mode, the seat portion 20, the leg support portion 30, and the backrest portion 40 work together to maintain the treated subject in a lying-flat position. For example, the leg support surface (the upper surface of the connecting plate 32 in the illustrated example; in a case where the leg support portion covering portion is provided, it corresponds to the portion of the leg support portion covering portion that is contact with the shanks of the treated subject during use) of the leg support portion 30 forms a leg portion angle B that is slightly greater than 180°, relative to the seat surface of the seat portion 20. The back support surface (the upper surface of the backrest portion 40 in the illustrated example; when the backrest portion covering portion is provided, it corresponds to the portion of the backrest portion covering portion that is in contact with the back of the treated subject during use) of the backrest portion 40 forms the backrest portion angle C that is slightly less than 180°, relative to the seat surface of the seat portion 20.

In order to set the massager 1 to the lying-flat mode, the leg support portion driving device 60 (specifically, the leg portion driving connecting rod 62 that rotates due to the extension and retraction of the leg portion actuating rod 61) may drive the leg support portion 30 to rotate, to thus set the leg portion angle B to any angle in a specified range. The extension and retraction of the actuating rods 51 and 52 for the front and rear connecting rods 811 and 821 may drive the front connecting rod 811 and the rear connecting rod 821 to rotate and to cause the first guided members 812 and the second guided members 822 to slide along the first guide rails 121 and the second guide rails 122, respectively, thereby driving the seat portion 20 to rotate to thus set the seat surface angle A of the seat portion 20 to a predetermined specified angle, and then the backrest portion driving device 70 (specifically, the extension and retraction of the backrest portion actuating rod 71) drives the backrest portion 40 to rotate, to thus set the backrest portion angle C to an angle in a specified range. Alternatively, after the backrest portion angle C is adjusted to the predetermined angle, the seat portion driving device 50 may be driven to rotate the seat portion 20, to thus set the seat surface angle A of the seat portion 20 to a predetermined specified angle; and the leg support portion driving device 60 drives the leg support portion 30 to rotate, to thus set the leg portion angle B to any angle in a specified range. By adjusting the seat surface angle A, the leg portion angle B, and the backrest portion angle C, the leg support portion 30, the seat portion 20, and the backrest portion 40 work together to achieve a state allowing for lying-flat of the treated subject.

Furthermore, the zero-gravity mode refers to a state in which the treated subject may have a posture with the trunk and legs at an angle of about 128 ± 8 degrees. In this state, the seat surface angle A of the seat portion 20 is approximately 35° ± 5°, and the backrest portion 40 and the seat surface of the seat portion 20 are in a V-shaped angle, for example, at about 128 ± 8 degrees. When the treated subject is in the zero-gravity mode, his/her heart and knees are approximately at the same level, or the lower limbs (e.g., feet) of the treated subject are higher than the heart. This helps promote blood circulation and reduce the burden on the heart. At the same time, the body weight of the treated subject is evenly distributed to prevent excessive load bearing of a part or some parts of the body, thereby minimizing the pressure on muscles and bones.

Here, as shown in FIG. 3, in the zero-gravity mode, the rollers constituting the first guided members 812 are located at the uppermost ends of the grooves constituting the first guide rails 121, and the rollers constituting the second guided members 822 are located at the lowermost ends of the grooves constituting the second guide rails 122. Hence, the front end of the seat surface of the seat portion 20 is higher than the rear end (in the illustrated example, the front end is much higher than the rear end).

In order to set the massager 1 to the zero-gravity mode, the leg support portion driving device 60 may drive the leg support portion 30 to rotate, to thus set the leg portion angle B to any angle in a specified range. The seat portion driving device 50 (specifically, the extension and retraction of the actuating rods 51 and 52 for the front and rear connecting rods 811 and 821) may drive the front connecting rod 811 and the rear connecting rod 821 to rotate and to cause the first guided members 812 and the second guided members 822 to slide along the first guide rails 121 and the second guide rails 122, respectively, thereby driving the seat portion 20 to rotate to thus set the seat surface angle A of the seat portion 20 to a predetermined specified angle, and then the backrest portion driving device 70 (specifically, the extension and retraction of the backrest portion actuating rod 71) drives the backrest portion 40 to rotate, to thus set the backrest portion angle C to an angle in a specified range. Alternatively, after the backrest portion angle C is adjusted to the predetermined angle, the seat portion driving device 50 may be driven to rotate the front connecting rods 811 and the rear connecting rods 821, and to drive the first guided members 812 and the second guided members 822 to slide along the first guide rails 121 and the second guide rails 122 to increase or reduce the seat surface angle A, thereby adjusting the height of the front end of the seat portion 20, such that the front end of the seat portion 20 is higher than, equal to, or lower than a specific position of the backrest portion 40. In the zero-gravity mode, the specific position of the backrest portion 40 refers to the position of the backrest portion 40 corresponding to the heart of the treated subject. The position of the heart of the treated subject may be detected or estimated by conventional body shape detection methods.

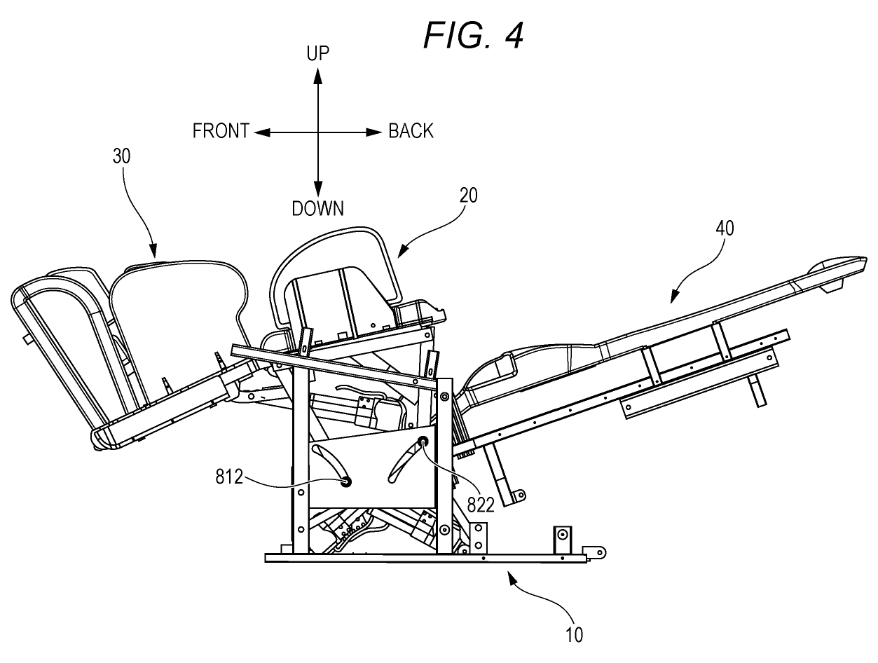

Furthermore, as shown in FIG. 4, in the lumbar stretch mode, the rollers constituting the first guided members 812 are located at the lowermost ends of the grooves constituting the first guide rails 121, and the rollers constituting the second guided members 822 are located at the uppermost ends of the grooves constituting the second guide rails 122. Hence, the front end of the seat surface of the seat portion 20 is lower than the rear end (in the illustrated example, the front end is much lower than the rear end). Moreover, at least a part of the backrest portion 40 close to the seat portion 20 is lower than the rear end of the seat portion 20. In the lumbar stretch mode, the leg portion angle B of the leg support portion 30 and the backrest portion angle C of the backrest portion 40 may be approximately set as needed. For example, the leg portion angle B of the leg support portion 30 may be set to be slightly greater than 180°, and the backrest portion angle C of the backrest portion 40 may be set to be slightly less than 180°.

In order to set the massager 1 to the lumbar stretch mode, the seat portion driving device 50 (specifically, the extension and retraction of the actuating rods 51 and 52 for the front and rear connecting rods 811 and 821) may drive the front connecting rod 811 and the rear connecting rod 821 to rotate, and to cause the first guided members 812 and the second guided members 822 to slide along the first guide rails 121 and the second guide rails 122, respectively, thereby driving the seat portion 20 to rotate to set the seat surface angle A of the seat portion 20 to a predetermined specified angle, and then the backrest portion driving device 70 (specifically, the extension and retraction of the backrest portion actuating rod 71) drives the backrest portion 40 to rotate, to thus set the backrest portion angle C to an angle in a specified range. Alternatively, after the backrest portion angle C is adjusted to the predetermined angle, the seat portion driving device 50 may be driven to rotate the seat portion 20, to thus set the seat surface angle A of the seat portion 20 to a predetermined specified angle.

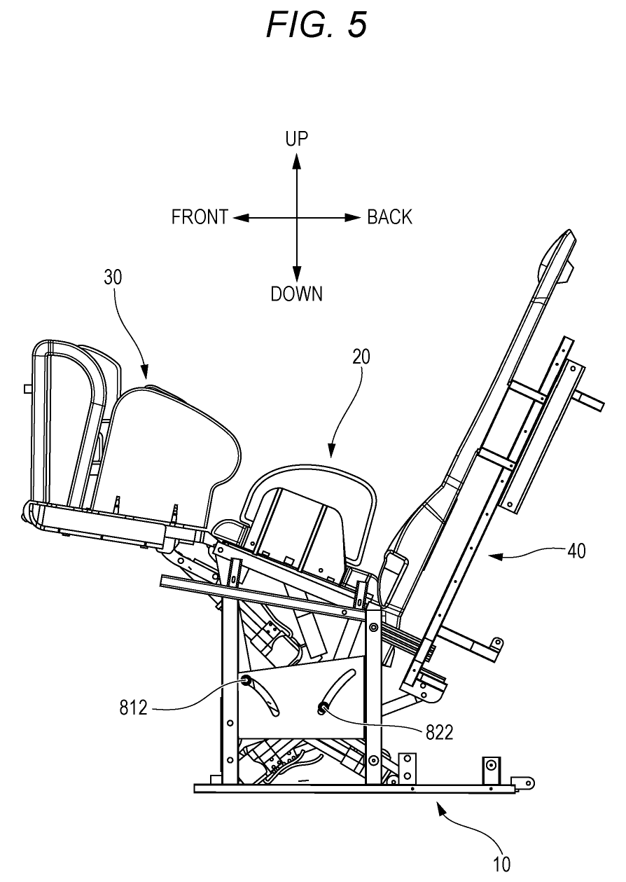

Furthermore, as shown in FIG. 5, in the compression mode, the rollers constituting the first guided members 812 are located at the uppermost ends of the grooves constituting the first guide rails 121, and the rollers constituting the second guided members 822 are located at the lowermost ends of the grooves constituting the second guide rails 122. Hence, the front end of the seat surface of the seat portion 20 is higher than the rear end (in the illustrated example, the front end is much higher than the rear end). Moreover, the end of the leg support portion 30 away from the seat portion 20 and the end of the backrest portion 40 away from the seat portion 20 are brought closer to each other. In the compression mode, the leg portion angle B of the leg support portion 30 and the backrest portion angle C of the backrest portion 40 may be appropriately set as needed. For example, the leg portion angle B of the leg support portion 30 may be set to be slightly greater than 180°, and the backrest portion angle C of the backrest portion 40 may be set to be close to 90°.

In order to set the massager 1 to the compression mode, the leg support portion driving device 60 (specifically, the leg portion driving connecting rod 62 that rotates due to the extension and retraction of the leg portion actuating rod 61) may drive the leg support portion 30 to rotate, to thus set the leg portion angle B to any angle in a specified range. The seat portion driving device 50 (specifically, the extension and retraction of the actuating rods 51 and 52 for the front and rear connecting rods 811 and 821) may drive the front connecting rod 811 and the rear connecting rod 821 to rotate and to cause the first guided members 812 and the second guided members 822 to slide along the first guide rails 121 and the second guide rails 122, respectively, thereby driving the seat portion 20 to rotate to thus set the seat surface angle A of the seat portion 20 to a predetermined specified angle, and then the backrest portion driving device 70 (specifically, the extension and retraction of the backrest portion actuating rod 71) drives the backrest portion 40 to rotate, to thus set the backrest portion angle C to an angle in a specified range. Alternatively, after the backrest portion angle C is adjusted to the predetermined angle, the seat portion driving device 50 may be driven to rotate the seat portion 20, to thus set the seat surface angle A of the seat portion 20 to a predetermined specified angle; and the leg support portion driving device 60 drives the leg support portion 30 to rotate, to thus set the leg portion angle B to any angle in a specified range. By adjusting the seat surface angle A, the leg portion angle B, and the backrest portion angle C, the leg support portion 30, the seat portion 20, and the backrest portion 40 work together to achieve a state in which the buttocks or waist of the treated subject are/is lower than both the feet and the shoulders. That is, the position(s) corresponding to the seat portion 20 or to the seat portion 20 and the backrest portion 40 correspond to the parts (e.g., the buttocks or waist) of a human body at the lowest positions.

### Main Effects

According to the massager 1 in this embodiment, the front driving device and the rear driving device are configured to actuate the front support member 81 and the rear support member 82 to move, respectively, thereby enabling the front end and the rear end of the seat portion 20 to move independently in an up-and-down direction. In this way, the range of the seat surface angle A of the seat portion 20 can be freely adjusted to provide an abundance of massage modes.

Furthermore, according to the massager 1 in this embodiment, in the front-to-back direction, the actuating rods 51 and 52 for the front and rear connecting rods 811 and 821 are located between the lower ends of the second front connecting rods 8112 and the lower ends of the second rear connecting rods 8212. In this way, the seat portion driving device 50 is compact in the front-to-back direction, contributing to the miniaturization of the massager 1.

Furthermore, in the massager 1 of the present disclosure, the lower end of the actuating rod 51 for the front connecting rods 811 is rotationally connected to a part of the base portion 10 close to the rear side, and the lower end of the actuating rod 52 for the rear connecting rods 821 is rotationally connected to a part of the base portion 10 close to the front side. In this way, it is easy to increase the amounts of movement, which are correspondingly generated based on the amounts of extension/retraction of the actuating rods 51 and 52 for the front and rear connecting rods 811 and 821, of the front and rear ends of the seat portion 20 in the up-and-down direction, thereby further expanding the adjustment range of the seat surface angle A of the seat portion 20.

The present invention has been described by way of example with reference to the accompanying drawings. Obviously, the specific implementation of the present invention is not limited by the embodiment described above.

For example, in the embodiment described above, the backrest portion 40 is rotationally connected to the base portion 10. However, it is not limited to this, and the backrest portion 40 may also be rotationally connected to the rear end of the seat portion 20. In this case, the backrest portion driving device 70 may also cause the backrest portion 40 to move relative to the seat portion 20.

In addition, in the embodiments described above, the first guide rails 121 and the second guide rails 122 are arranged in the front-to-back direction, but it is not limited to this. The first guide rails 121 and the second guide rails 122 may also be arranged in the up-and-down direction, or in the left-to-right direction.

Furthermore, in the embodiments described above, the first guide rails 121 and the second guide rails 122 are approximately the same in length and radius, and may also be formed to be different.

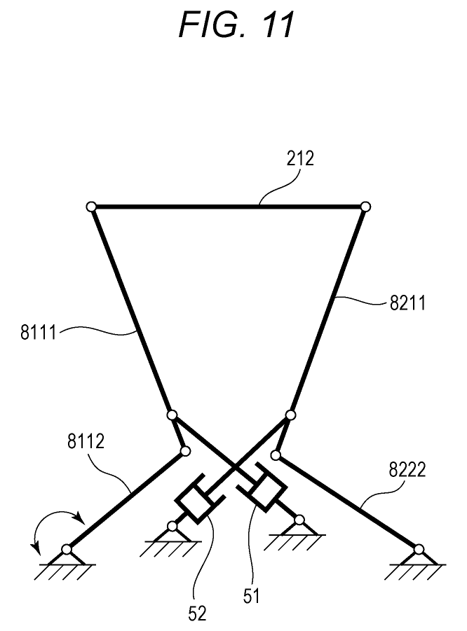

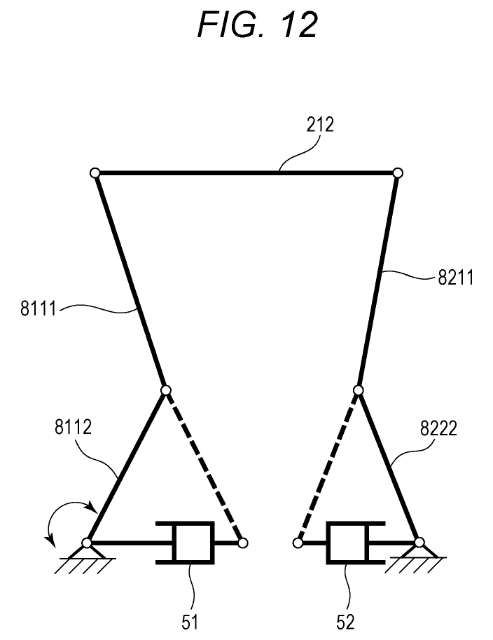

Furthermore, in the embodiments described above, as shown in FIG. 11, the actuating rods 51 and 52 for the front and rear connecting rods 811 and 821 as included in the seat portion driving device 50 are inclined with respect to the horizontal plane, respectively, and each has one end moving in the up-and-down direction. However, it is not limited to this. As shown in FIG. 12, the front connecting rod 811 and the rear connecting rod 821 (the dotted line on the left in the figure represents a front extension rod that is integrally formed with the first front connecting rod 8111 and has the same length as the second front connecting rod 8112, and the dotted line on the right in the figure represents a rear extension rod that is integrally formed with the first rear connecting rod 8211 and has the same length as the second rear connecting rod 8212) are appropriately arranged, such that the actuating rods 51 and 52 for the front and rear connecting rods 811 and 821 may also be formed to be parallel to the horizontal plane and to move only in the horizontal plane.

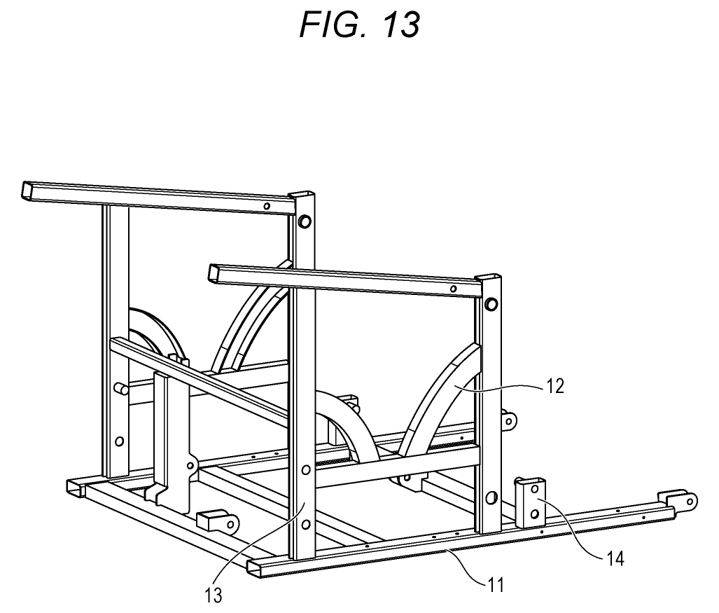

Furthermore, in the embodiments described above, the guide rail portions 12 are plate-shaped. However, it is not limited to this. As shown in FIG. 13, the guide rail portions 12 may also be formed by a plurality of rod-shaped portions. The guide rail portions 12 may also be formed as toothed guide rails, and the guided members may be formed as moving gears corresponding thereto.

Furthermore, in the embodiments described above, the first front connecting rods 8111 are longer than the second front connecting rods 8112, and the first rear connecting rods 8211 are longer than the second rear connecting rods 8212. However, it is not limited to this. The length of each first front connecting rod 8111 may also be the same as or less than the length of each second front connecting rod 8112, and the length of each first rear connecting rod 8211 may also be the same as or less than the length of each second rear connecting rod 8212.

Furthermore, in the embodiments described above, the front connecting rods 811 each include the first front connecting rod 8111 and the second front connecting rods 8112 that are hinged to each other, and the rear connecting rods 821 each include the first rear connecting rod 8211 and the second rear connecting rod 8212 that are hinged to each other. However, it is not limited to this. The second front connecting rods 8112 and the second rear connecting rods 8212 may also be omitted. In this case, two rollers as first guided members may be arranged at intervals on the first front connecting rods 8111, and two rollers as second guided members may be arranged at intervals on the first rear connecting rods 8211, in order to ensure a stable posture of the seat portion 20.

Furthermore, in the embodiments described above, the specific structures of the base portion 10, the seat portion 20, the leg support portion 30, the backrest portion 40, the seat portion driving device 50, the leg support portion driving device 60, and the backrest portion driving device 70 may be appropriately changed as needed.

Furthermore, in the embodiments described above, in the stand-up assist mode, the leg support portion 30 and the backrest portion 40 may also be driven, respectively, to a state suitable for the treated subject to stand up. For example, the leg portion angle B may be set to be less than 270° but greater than 180°, and the backrest portion angle C may be set to an angle within the range of 80°-110°. The adjustment steps described above may be performed in any order. Alternatively, the seat surface angle A and the leg portion angle B may be adjusted first, followed by the backrest portion angle C, such that the backrest portion 40 can provide the treated subject with a back push force from back to front, thereby further assisting the treated subject to stand up. In the stand-up assist mode, the front end of the seat portion 20 may also be approximately flush with the rear end.

Furthermore, in the embodiments described above, the massager 1 may also have a standby mode, for example. In the standby mode, the front end of the seat surface of the seat portion 20 may be slightly higher than or flush with the rear end. In this way, the treated subject is allowed to sit comfortably and maintain an initial posture suitable for entering other massage modes.

It should be understood that within the scope of the present invention, various parts of the embodiments can be freely combined, or appropriately modified or omitted.

What is claimed is:

1. A massager comprising:
a base portion having a first guide rail and a second guide rail;
a support member having a front support member and a rear support member that are movable independently of each other;
a seat portion supported on the base portion via the support member; and
a seat portion driving device configured to adjust the seat portion by driving the support member,
the front support member being rotationally connected to a front end of the seat portion, the front support member being configured to be driven by the seat portion driving device and guided by the first guide rail to move the front end of the seat portion in an up-and-down direction, and
the rear support member being rotationally connected to a rear end of the seat portion, the rear support member being configured to be driven by the seat portion driving device and guided by the second guide rail to move the rear end of the seat portion in the up-and-down direction.

2. The massager according to claim 1, wherein
the front support member includes a front connecting rod that is rotationally connected to the front end of the seat portion, and a first guided member that is arranged on the front connecting rod so as to move along the first guide rail, and
the rear support member includes a rear connecting rod that is rotationally connected to the rear end of the seat portion, and a second guided member that is arranged on the rear connecting rod so as to move along the second guide rail.

3. The massager according to claim 2, wherein
the front connecting rod includes a first front connecting rod and a second front connecting rod that are rotatably connected via a front rotating shaft portion, with an end of the first front connecting rod away from the front rotating shaft portion being rotationally connected to the front end of the seat portion, and an end of the second front connecting rods away from the front rotating shaft portion being rotationally connected to the base portion, and
the rear connecting rod includes a first rear connecting rod and a second rear connecting rod that are rotatably connected via a rear rotating shaft portion, with an end of the first rear connecting rod away from the rear rotating shaft portion being rotationally connected to the rear end of the seat portion, and an end of the second rear connecting rod away from the rear rotating shaft portion being rotationally connected to the base portion.

4. The massager according to claim 3, wherein
the first guided member is arranged at a midpoint of the first front connecting rod in a length direction, and
the second guided member is arranged at a midpoint of the first rear connecting rod in a length direction.

5. The massager according to claim 3, wherein
the seat portion driving device includes a front driving device with a telescopic actuating rod for the front connecting rod, and a rear driving device with a telescopic actuating rod for the rear connecting rod,
the actuating rod for the front connecting rod having one end rotationally connected directly or indirectly to a midpoint of the first front connecting rod in a length direction, and the other end connected to the base portion, and
the actuating rod for the rear connecting rod having one end rotationally connected directly or indirectly to a midpoint of the first rear connecting rod in a length direction, and the other end connected to the base portion.

6. The massager according to claim 5, wherein
in a front-to-back direction, the actuating rod for the front connecting rod and the actuating rod for the rear connecting rod are located between an end of the second front connecting rod and an end of the second rear connecting rod.

7. The massager according to claim 1, wherein
the first guide rail is formed such that a height thereof increases as extending toward a front portion of the massager, and
the second guide rail is formed such that a height thereof increases as extending toward a rear portion of the massager.

8. The massager according to claim 1, further comprising
a leg support portion rotationally connected to the front end of the seat portion, and
a backrest portion rotationally connected to the base portion or to the rear end of the seat portion.

9. The massager according to claim 8, further comprising
a leg support portion driving device causing the leg support portion to move relative to the seat portion, and
a backrest portion driving device causing the backrest portion to move relative to the base portion or the seat portion.

10. A massager control method for controlling the massager according to claim 9, the massager control method comprising:
controlling the seat portion driving device, the leg support portion driving device, and the backrest portion driving device to cause the massager to perform at least one of a stand-up assist mode, a lying-flat mode, a zero-gravity mode, a compression mode, and a lumbar stretch mode,
in the stand-up assist mode, a front end of a seat surface of the seat portion being positioned lower than or substantially flush with a rear end;
in the lying-flat mode, a seat surface angle of the seat portion being adjusted such that the seat portion, the leg support portion, and the backrest portion work together to achieve a state allowing for lying-flat of a treated subject;
in the zero-gravity mode, the front end of the seat surface of the seat portion being positioned higher than the rear end, an end of the leg support portion away from the seat portion being positioned lower than an end of the leg support portion close to the seat portion, and an end of the backrest portion away from the seat portion being positioned higher than an end of the backrest portion close to the seat portion;
in the compression mode, the end of the leg support portion away from the seat portion and the end of the backrest portion away from the seat portion being brought closer to each other, and
in the lumbar stretch mode, the front end of the seat surface of the seat portion being positioned lower than the rear end, and at least part of the backrest portion close to the seat portion being positioned lower than the rear end of the seat portion.
